(19) United States
(12) Patent Application Publication
(10) Pub. No.: US 2014/0297309 A1
(43) Pub. Date: Oct. 2, 2014

(54) SYSTEM AND METHOD FOR SUPPLYING MEDICAL IMAGE

(71) Applicant: Infinitt Healthcare Co., Ltd., Seoul (KR)

(72) Inventors: Tae Hyun Kim, Seoul (KR); Min Sung Kim, Seoul (KR)

(73) Assignee: INFINITT HEALTHCARE CO., LTD.

(21) Appl. No.: 14/303,975

(22) Filed: Jun. 13, 2014

Related U.S. Application Data
(63) Continuation of application No. PCT/KR2012/010943, filed on Dec. 14, 2012.

(30) Foreign Application Priority Data
Dec. 14, 2011 (KR) 10-2011-0134860

(51) Int. Cl. G06F 19/00

(52) U.S. Cl. CPC G06F 19/321
USPC 705/2

(57) ABSTRACT

The present invention relates to a system and method for providing medical images. The system for providing medical images according to an example of the present invention includes: one or more software viewer modules; a software user-specified worklist management module; and a software display controller module. The one or more software viewer modules display medical images. The user-specific worklist management module provides a user-specific worklist corresponding to a logged-in user, based on the role of the logged-in user, via a worklist interface which provides varying functions. The display controller module controls one or displaying monitors to display detailed information and medical images for a list, selected from among user-specific worklist, via the one or more software viewer modules based on status information on the one or more software viewer modules.

### CROSS-REFERENCE TO RELATED APPLICATION

This application is a continuation of PCT/KR2012/010943 filed on Dec. 14, 2012, which claims priority to Korean Application No. 10-2011-0134860 filed on Dec. 14, 2011, which application is incorporated herein by reference.

### TECHNICAL FIELD

The present invention relates to a system and method for providing medical images and, more particularly, to a system and method that are capable of providing a role-based worklist and display settings for each of logged-in user.

### BACKGROUND ART

In general, a picture archiving & communication system (PACS) is a system in which the physical regions of patients are imaged via various types of medical equipment and images are transmitted in a digital manner and then read via computers.

A PACS acquires the image information of patients, imaged using various types of imaging equipment, such as a computed tomography (CT) scanner, a magnetic resonance imaging (MRI) scanner, a fluoroscopy machine, a computed tomography angiography (CTA) scanner, etc., in a hospital or a clinic, in a digital form, rather than a film form, stores it in a digital storage medium, and transmits it to terminals over a network, thereby enabling the image information of the patients to be searched, interpreted and used for diagnosis in real time in any place where a terminal is present, such as an examination room, a ward, or the like.

In a PACS, searches for patient information are chiefly made using worklists, and medical images of patients are searched for in compliance with specific rules required by a hospital. FIG. 1 is a diagram illustrating a screen that is used to search for a medical image of a patient in a conventional PACS.

A worklist is a set of lists in which tasks that need to be performed by each user who searches, reads and records patient information in a hospital, such as a clinician, a technician, a radiologist or a transcriber, in the day have been recorded. A user searches for information required for the user from medical information, such as medical images, patient information and imaging information, via a worklist, and reads and examines information provided via a software viewer module. If a user is a radiologist, he or she searches for details of records of medical images to be read in the day from a worklist, and reads and examines medical images provided via a software viewer module.

A conventional interface technology for providing a worklist provides a worklist so that the worklist provides only activities of one or two limited scopes or enables a single task. The reason for this is that the worklist interface is supplied in the form of being dependant on separate dedicated software. Accordingly, the conventional interface technology is problematic in that it is difficult to smoothly reflect changes onto an overall worklist database when users perform tasks in accordance with only their roles, and it is difficult to customize the worklist interface.

An attempt to improve the conventional technology for managing worklists is described in U.S. Pat. No. 7,756,724 entitled “System and Methods for Real-time Worklist Service.” In accordance with the present preceding technology, a worklist database management module that manages a worklist database in an integrated manner is separately provided, rapid updates are provided to minimize errors attributable to the changed information of worklists, and a worklist including overlap information is provided. An example of the conventional worklist interface screen of FIG. 1 can be obtained from the present preceding technology.

Meanwhile, the preceding technology has achieved the purposes of the integrated management of a worklist database and rapid updates to a certain extent, but is still insufficient to achieve the purpose of the provision of a worklist interface optimized for each user. A worklist interface that is provided by the preceding technology does not provide activities of various scopes, but provides only activities of limited scopes.

The reason why the tasks of the worklist interface are limited as described above is that a worklist interface module was implemented to be dependent on viewer software modules installed in work stations. For example, since the user group of a 2D medical image viewer is not consistent with the user group of a 3D medical image viewer, the designer of each of the software viewer modules implements software based on biased assumption about the role of a corresponding user group. Accordingly, the scope of activities provided by a worklist interface dependent on the 2D medical image viewer is different from the scope of activities provided by a worklist interface dependent on the 3D medical image viewer, and thus the user customization of the worklist interfaces is not easy.

As described above, in the conventional technology, worklists are provided to all users who use the same viewer via the same interface, and thus information unnecessary for a specific user and related to other users, in addition to a list of tasks that should be performed by the specific user, is provided, thereby causing the problem of low efficiency.

### SUMMARY OF THE DISCLOSURE

An object of the present invention is to provide an interface including a function or a combination of functions required for each user to the user and also to provide a worklist using the interface, thereby preventing unnecessary information from being provided in order to meet the role of each user and also providing one or more medical images via a user interface (UI) that is most convenient for the use of the user.

Another object of the present invention is to manage and control the display settings of specialized software viewer modules.

A further object of the present invention is to apply a list selected by a user to all software viewer modules in an integrated manner, and also to conveniently and rapidly make an update with the changed information of a worklist.

In order to accomplish the above objects, the present invention provides a system for providing a medical image, including one or more software viewer modules, a software user-specified worklist management module, and a software display controller module. The one or more software viewer modules display medical images. The software user-specified worklist management module provides a user-specified worklist corresponding to a logged-in user via a worklist interface that provides functions varying depending on the role of the logged-in user. The software display controller module controls one or monitors to display detailed information and medical images related to a list selected from the user-specified worklist via the one or more software viewer modules based on status information of the one or more software viewer modules.

In accordance with the above configuration, a worklist including required functions can be provided to each user, thereby achieving the effect of being convenient for the use of all users.

In accordance with the present invention described above, the user-specified worklist management module provides a user-specified worklist corresponding to a logged-in user via a worklist interface that provides functions varying depending on the role of the logged-in user, and thus a worklist including functions required for each user can be provided, thereby being convenient for the use of all users and accordingly achieving the effect of maximizing the degree of satisfaction of the user.

Furthermore, the user-specified worklist management module and the software viewer modules are configured independently of each other, and thus medical information corresponding to a list can be provided in accordance with each of the specialized software viewer modules when a user selects the list from a user-specified worklist, thereby achieving the effect of being convenient for use and the effect of enabling a simple and rapid update to be made when the information of the list changes. That is, the user-specified worklist interface is implemented not to be dependent on the software viewer modules and implemented at a level equal to that of the software viewer modules, and thus it can be easily optimized for each user. Moreover, the display controller module performs control so that the detailed information and one or more medical images of a list selected from a user-specified worklist are displayed via the one or more software viewer modules in accordance with the status information of the software viewer modules, that is, by reflecting the role of a user, the first status information of the software viewer modules and a second status information of one or more monitors, thereby achieving the effect of providing medical information using an optimum UI that is most convenient for the use of the user.

That is, the user-specified worklist management module and worklist interfaces of the present invention, together with the image software viewer modules, are controlled by the display controller module, and thus optimization over an overall display environment(status information of one or more monitors or consoles) can be performed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a screen that is used to search for a medical image of a patient in a conventional PACS;

FIG. 2 is a diagram illustrating the schematic configuration of a system for providing medical images according to an example of the present invention;

FIGS. 3A through 3F are diagrams illustrating examples of user-specified worklists that are provided by the user-specified worklist management module of FIG. 2;

FIGS. 4A through 4D are diagrams illustrating screens in which the software viewer modules of FIG. 2 display one or more medical images according to the numbers of monitors;

FIG. 5 is a diagram illustrating the schematic flow of a method of providing a medical image according to an example of the present invention; and

FIGS. 6A and 6B are diagrams illustrating screens in which a user-specified worklist is provided and a medical image corresponding to a selected list is applied to each software viewer module.

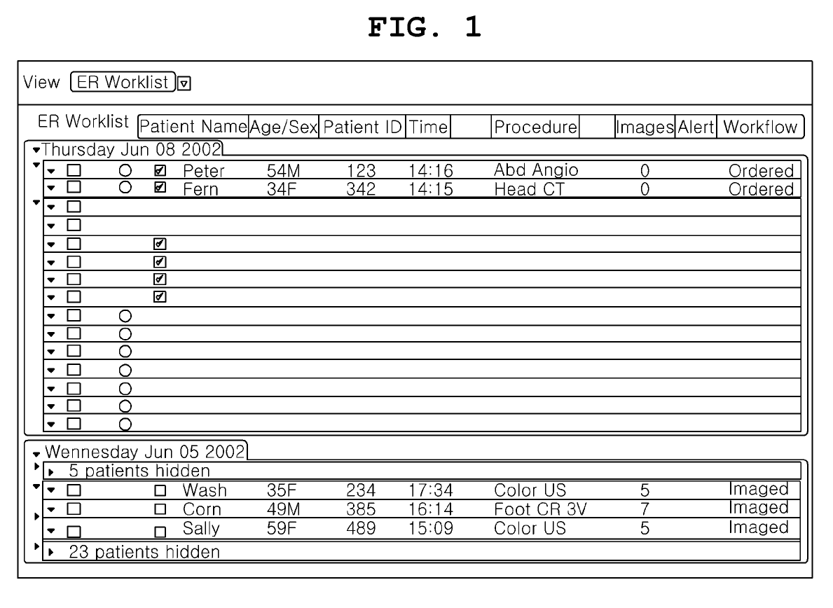

### DETAILED DESCRIPTION OF THE DISCLOSURE

Hereinafter, preferred embodiments of the present invention are described in detail with reference to the accompanying drawings. In the following description of the present invention, detailed descriptions of known configurations or functions that may unnecessarily make the gist of the present invention obscure will be omitted. Furthermore, in the following description of embodiments of the present invention, specific numerical values correspond merely to embodiments, and exaggerated numerical values different from actual values may be presented for ease of description and understanding of the embodiments.

### Description of System

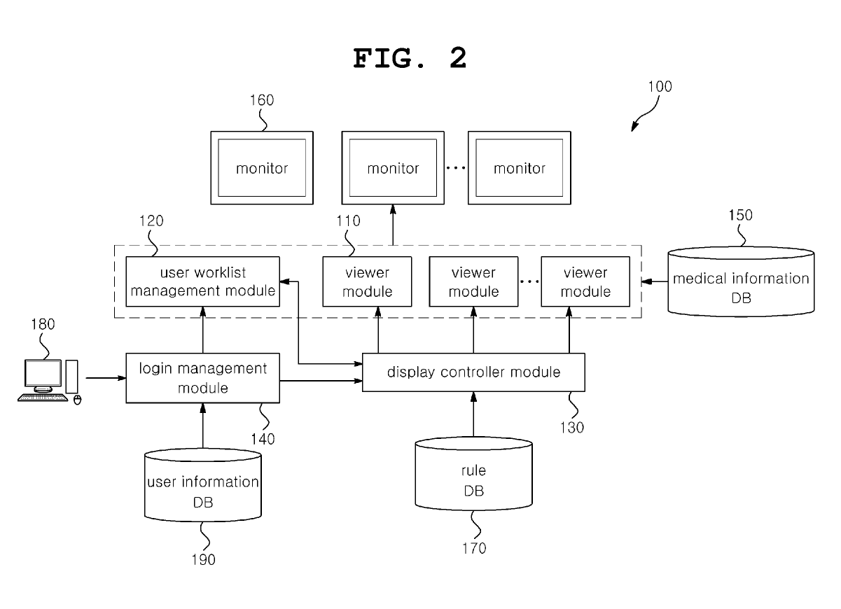

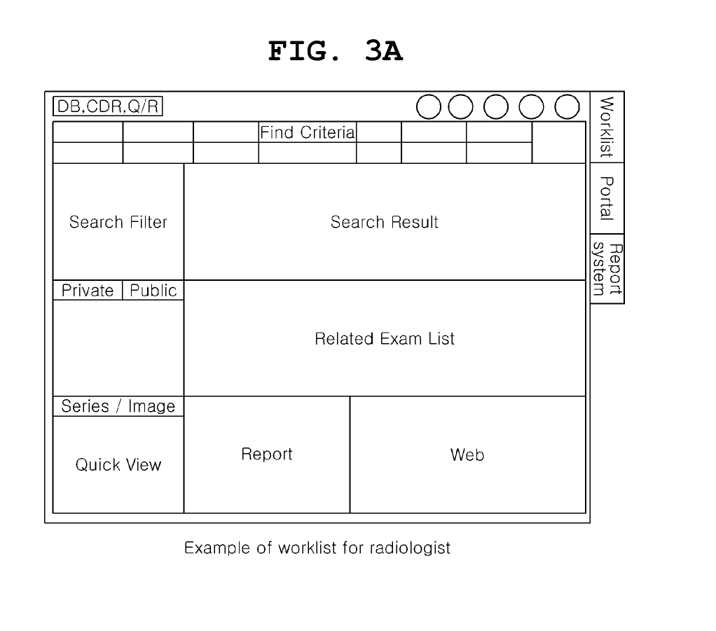

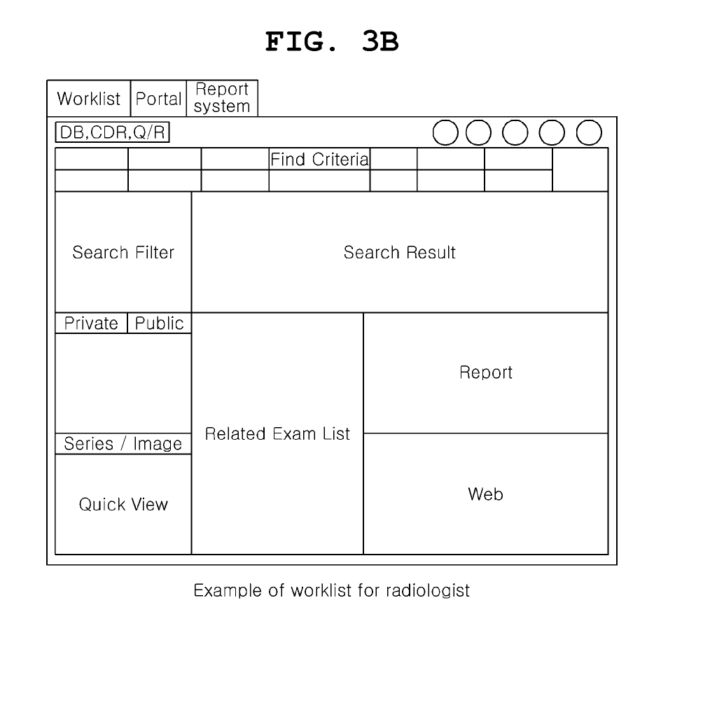

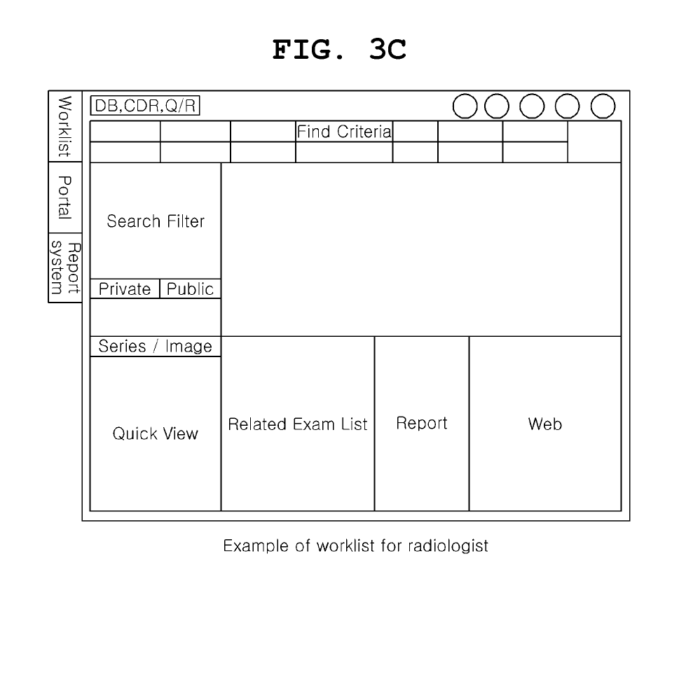

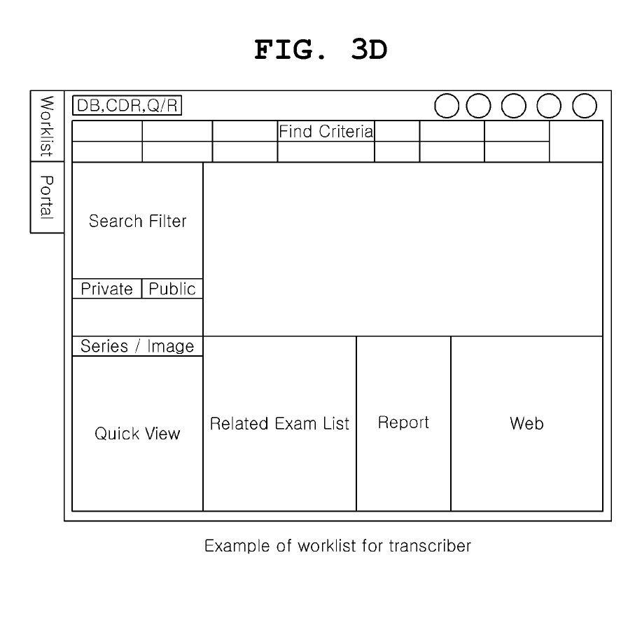

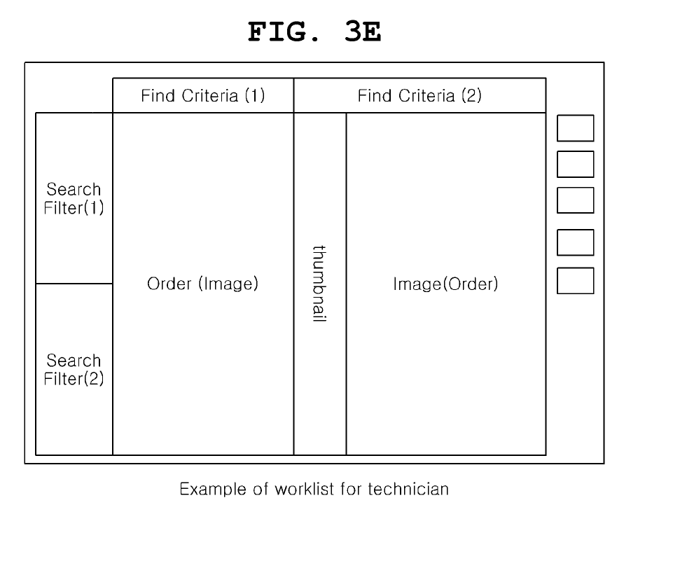

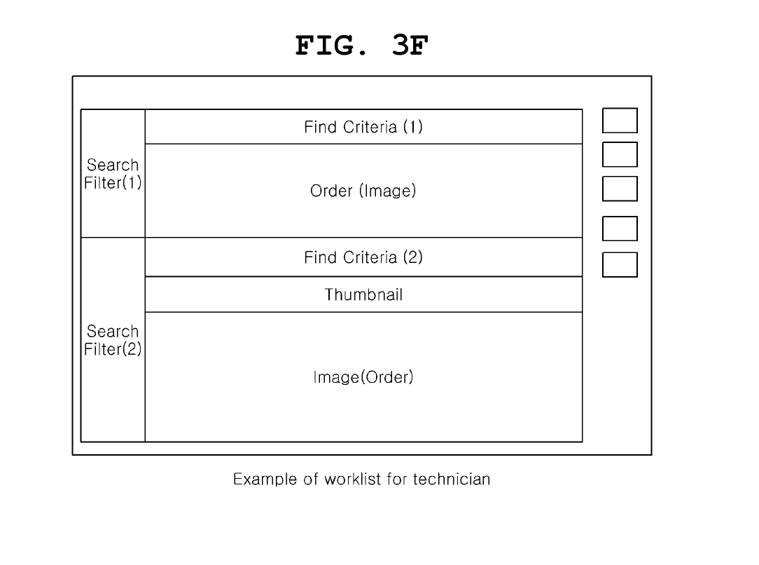

FIG. 2 is a diagram illustrating the schematic configuration of a system for providing a medical image according to an example of the present invention, and FIGS. 3A to 3F are diagrams illustrating examples of user-specified worklists that are provided by the user-specified worklist management module of FIG. 2.

Referring to FIG. 2, a computing system for providing a medical image 100 according to an example of the present invention includes a processor(not shown). The processor may run one or more software viewer modules 110, a software user-specified worklist management module 120, a software display controller module 130, and a software login management module 140.

The one or more software viewer modules 110 communicate with a medical information database 150 in which medical information, such as medical images acquired by imaging equipment (for example, a CT scanner, or an MRI scanner), patient information (for example, the IDs, names and genders of patients) and imaging information (for example, imaging equipment, and imaging times), have been stored, and display medical information on the screens of monitors 160. In the present invention, it is preferred that the software viewer modules 110 include specialized software viewer modules, such as a 2D viewer module, a 3D viewer module and a cardiovascular viewer module, thereby being specialized for corresponding processes and then providing medical information. The reason for this is that to accurately determine the disease of a patient, only the provision of an imaged region in two dimensions may be sufficient or the realistically visualized provision of an image region in three dimensions may be required. For example, since a cerebrovascular image is complicated, it needs to be provided in the form of a 3D image because it is not easy to determine relationships using only a 2D image. In the case of the heart, not only a 3D image but also a cardiovascular image needs to be provided. As described above, software viewer modules specialized for images are required.

The user-specified worklist management module 120 provides a user-specified worklist corresponding to a logged-in user via a worklist interface that provides a function varying depending on the role of the logged-in user. A rule database 170 that communicates with the user-specified worklist management module 120 stores rule information related to the formats of provision of medical information based on conditions, such as the IDs of users, imaging equipment, and imaged regions.

In the present invention, a user-specified worklist is a set of lists in which tasks have been recorded that need to be performed in the day by each user who searches, reads and records medical information, and is a worklist including functions required based on the role of the user. The user selects a required list from a user-specified worklist provided via the worklist interface, and reads and examines medical images, patient information or the like provided onto the screens of the one or more monitors 160 via the software viewer module 110 in accordance with the selection.

In this case, the role of the logged-in user may correspond to at least one of a radiologist, a clinician, a technician and a transcriber. When the user is a radiologist, a corresponding user-specified worklist may be a set of lists in which medical images that need to be read in the day have been recorded, and the radiologist selects required medical images from the lists of the user-specified worklist and examines and interprets them. In an example, user-specified worklists to be provided (by user-specified worklist management module 120) to a radiologist, a clinician and a technician may be provided in formats, such as those illustrated in FIGS. 3A through 3F, and functions to be provided may include Find Criteria, Search Filter, Report System, Quick Search, Quick View, DICOM send, Messenger, Report, Web, and Order image. Of these functions, Find Criteria, Search Filter, Quick Search and Messenger may be provided to all users(common/general functions), Report System may be uniquely provided to a radiologist or clinician, and Quick View may be uniquely provided to a radiologist and a transcriber. A configuration may be made such that functions to be provided may vary depending on the role of a user. Find Criteria may be defined as a function that is capable of performing search using a combination of search conditions. As stated before, some functions are provided commonly/generally to all of roles, other functions are provided uniquely to some specific roles. User-specified worklist management module 120 may extract some functions to be applied to all roles, other functions applied uniquely to specified roles. User-specified worklist management module 120 may determine layout of worklist interface which provide general/common functions and uniquely role-specific functions, to each of logged-in user, based on the whose role. Various modifications may be applied to the present invention, and the present invention is not limited to a specific implementation method.

Meanwhile, it is preferred that if the information of a list selected from a user-specified worklist changes, the user-specified worklist management module 120 makes an update with the changed information of a list and transfer the update to one or more software viewer modules 110, thereby rapidly and accurately providing medical information.

The login management module 140 communicates with the user terminal 180 and receives an ID and a password input to the user terminal 180, extracts the role of the logged-in user using information about the logged-in user, and transfers information about the role of the logged-in user to the display controller module 130 and the user-specified worklist management module 120. In order to perform a login process, the login management module 140 communicates with the user information database 190 that stores user information (for example, the IDs, passwords and roles of users). Via the transfer of the information, the user-specified worklist management module 120 provides a user-specified worklist corresponding to the role of the logged-in user via the worklist interface. Furthermore, the display controller module 130 controls layouts and locations on the screens of the monitors 160 on which the worklist interface and the software viewer modules 110 are displayed in accordance with the role of the logged-in user, the number of software viewer modules 110 and a second status information of one or more monitors. This will be described in detail in the following description.

First, the display controller module 130 functions to perform control so that the detailed information of a list selected from a user-specified worklist and a medical image are displayed via one or more software viewer modules 110 in accordance with the status information of the one or more software viewer modules 110. The display controller module 130 determines the number of one or more software viewer modules 110 based on the role of a logged-in user. The reason for this is that the types of software viewer modules 110 that need to be provided to each user vary depending on the role of the user, as described in connection with the specialization of the software viewer module 110 above. That is, since required medical images vary depending on whether a user is a radiologist or a technician, it is preferred that the display control module 130 determines specialized software viewer modules for the medical images and the number of software viewer modules.

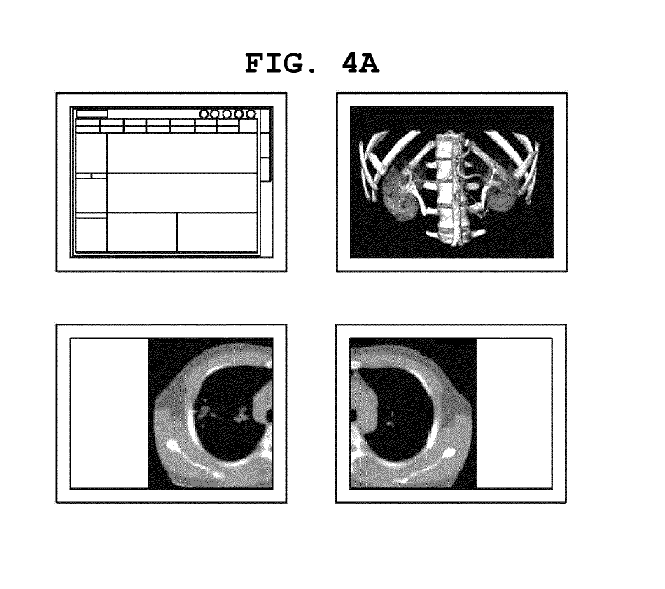

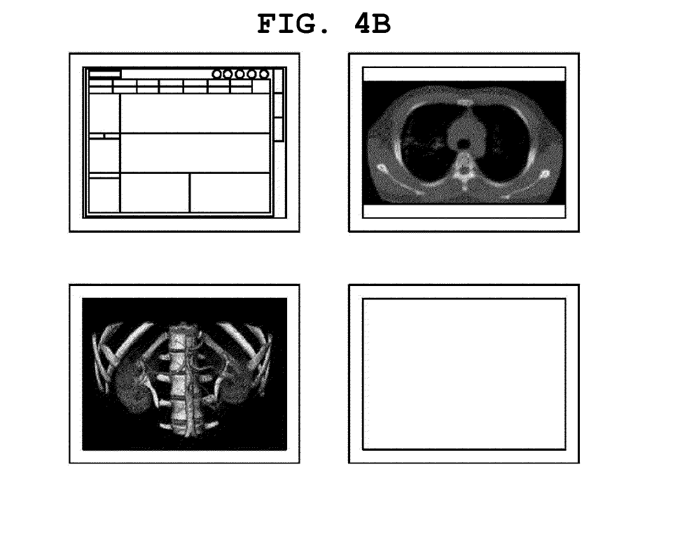

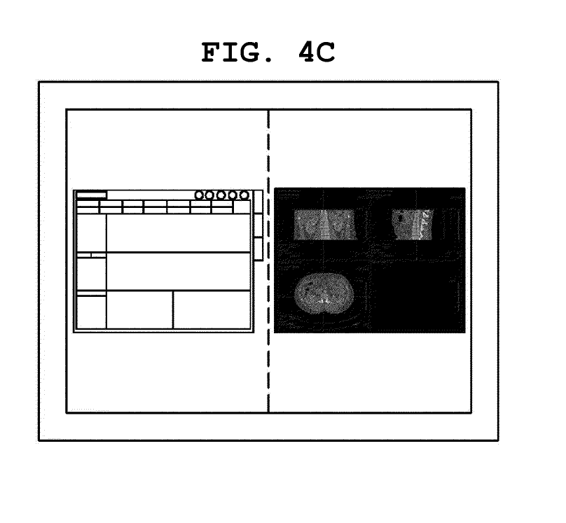

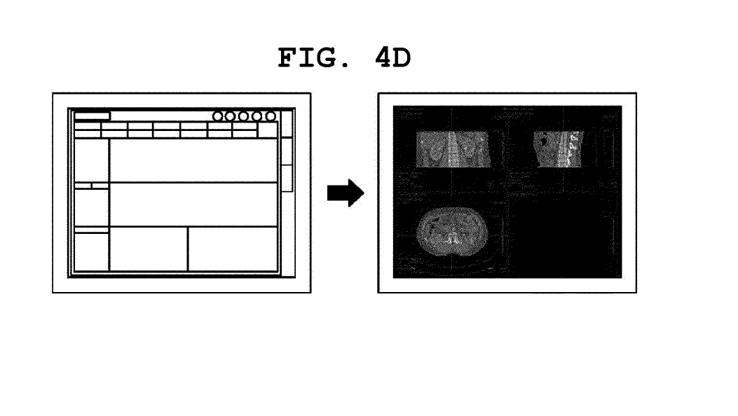

In the present invention, the status information of the software viewer modules 110 includes the number of software viewer modules 110, information about whether the number of software viewer modules 110 is consistent with the number of monitors 160, and setting information, such as layouts and locations on the screens of the monitors 160 on which the software viewer modules 110 are displayed. For example, if the number of software viewer modules is 2 and the number of monitors is 4, as illustrated in FIGS. 4A through 4D, the display controller module may make a setting that allocates a single software viewer module to two monitors so that a single medical image is displayed across the two monitor (FIG. 4A), or a setting that allocates two software viewer modules to two respective monitors so that a single monitor is not used (FIG. 4B). Furthermore, if the number of software viewer modules is 2 and a single monitor is used, a setting may be made such that a user-specified worklist is provided onto ½ of the screen thereof and the detailed information of a list selected from a user-specified worklist is provided onto the remaining portion, as if there are two monitors (FIG. 4C), or a setting may be made such that a user-specified worklist is provided onto the screen of the monitor and the user-specified worklist is hidden when the detailed information of the selected list is displayed (FIG. 4D).

The display environment(status information of one or more monitors) means attribute information, such as the number and sizes of monitors 160. Since it is difficult to determine relationships related to an image using a 2D image, a method of making a diagnosis while viewing an image reconstructed in 3D has become a current general method. Meanwhile, when a reconstructed image is viewed via a general monitor, the general monitor cannot represent depth information when displaying a 3D image, so that it is preferred that a plane medical image be provided via a general monitor and a 3D medical image be provided via a 3D dedicated monitor. Accordingly, in the present invention, the display controller module 130 controls layouts and locations on the screens of the monitors 160 in accordance with the display environment.

In a conventional technology, a worklist management module is dependent on software viewer modules, and thus a user executes a worklist interface via each software viewer module and selects an object to be displayed via the worklist interface. For example, when the software viewer modules include a 2D viewer module and a 3D viewer module, an inconvenience arises in which a user should select a list via worklist management modules dependent on the 2D viewer module and the 3D viewer module, respectively, in order to view the same imaged region in 2D and 3D. Furthermore, the same worklists dependent on the software viewer modules are provided to all users regardless of whether a user is a technician or some other clinician. Furthermore, since a list should be selected via each worklist module, it is difficult to perform optimization for each user. The user-specified worklist management module 120 of the present invention is configured to be executed as an equal-level process independent of the one or more software viewer modules 110, a user-specified worklist that is provided by the user-specified worklist management module 120 is determined based on whether a user is a technician, a radiologist or a transcriber, and the software viewer modules 110 display medical information in accordance with a command of the display controller module 130. In other words, the user-specified worklist management module 120 manages worklists corresponding to medical information that is displayed on the software viewer modules 110 in an integrated manner, thereby enabling medical information corresponding to a list selected from a user-specified worklist on the screens of corresponding one or more monitors 160 in accordance with the characteristics of the software viewer modules 110 (the settings of a display environment).

As described above, the user-specified worklist management module 120 provides a user-specified worklist corresponding to a logged-in user via a worklist interface that provides functions varying depending on the role of the logged-in user, and thus a worklist including functions required for each user can be provided, thereby achieving the effect of being convenient for the use of all users and accordingly the effect of maximizing the degree of satisfaction of the user.

Furthermore, the user-specified worklist management module 120 and the software viewer modules 110 are configured independently of each other, and thus medical information corresponding to a list can be provided in accordance with each of the specialized software viewer modules 110 when a user selects the list from a user-specified worklist, thereby achieving the effect of being convenient for use and the effect of enabling a simple and rapid update to be made when the information of the list changes.

Moreover, the display controller module 130 performs control so that the detailed information and one or more medical images of a list selected from a user-specified worklist are displayed via one or more software viewer modules 110 in accordance with the status information of the software viewer modules 110, that is, by taking into account the role of a user, the status information of the software viewer modules 110 and a display environment, thereby achieving the effect of providing medical information using an optimum UI that is most convenient for the use of the user.

### Description of Method

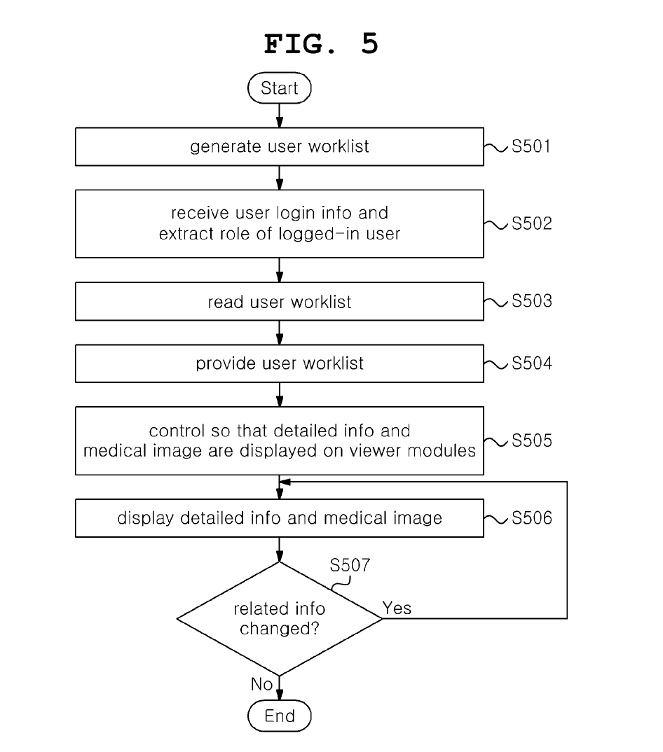

A method of providing a medical image according to an example of the present invention is described with reference to a flowchart illustrated in FIG. 5, and is described in a sequential manner for convenience of description.

### 1. Generation of User-Specified Worklist <S501>

The user-specified worklist management module 120 generates, stores, and manages user-specified worklists that provide different functions based on the roles of users, as illustrated in FIGS. 3A through 3F.

In the present invention, a user-specified worklist is a set of lists in which tasks have been recorded that need to be performed in the day by each user who searches, reads and records medical information, such as one or more medical images, patient information and imaging information, and is a worklist including functions required based on the role of the user.

Furthermore, the role of a user may correspond to at least one of a doctor (e.g., a radiologist or a clinician), a technician and a transcriber. When the user is a radiologist, a corresponding user-specified worklist may be a set of lists in which medical images that need to be read in the day have been recorded. User-specified worklists to be provided to a clinician, a radiologist, a transcriber and a technician may include combinations of functions, such as Find Criteria, Quick Search, Quick View, DICOM send, and Messenger. Find Criteria, Quick Search and Messenger may be provided to all users, and Quick View may be provided only to a radiologist and/or a clinician. A configuration may be made such that functions to be provided may vary depending on the role of a user. Various modifications may be applied to the present invention, and the present invention is not limited to a specific implementation method.

In this case, the user-specified worklists managed by the user-specified worklist management module 120 may be data that is read from a master database (not illustrated) in which worklists have been stored in an integrated manner. The user-specified worklist management module 120 may communicate with the master database in order to perform the synchronization of data periodically or when a worklist is changes by a user's input or a user.

### 2. Reception of User Login Information, and Extraction of Role of Logged-in User <S502>

When a subscribed user inputs an ID and a password via the user terminal 180, the login management module 140 receives the ID and the password, extracts the role of the logged-in user using information about the logged-in user, and transfers information about the role of the logged-in user to the display controller module 130 and the user-specified worklist management module 120.

### 3. Reading of User-Specified Worklist <S503>

The user-specified worklist management module 120 reads a user-specified worklist corresponding to the logged-in user.

### 4. Provision of User-Specified Worklist <S504>

This is the step of providing a user-specified worklist via the worklist interface that provides different functions based on the role of the logged-in user. At this step, a user-specified worklist corresponding to the role of the logged-in user is provided via the worklist interface. That is, as illustrated in FIGS. 3A through 3F, a worklist including functions varying depending on whether the role of the user corresponds to a radiologist or clinician, a technician, or a transcriber is provided.

Meanwhile, although the user-specified worklist interface to be displayed on one or more screens is basically configured based on the role, the configuration of the screens may be varied by taking into account a display environment (the sizes, resolutions and number of the one or more monitors, and the number of software viewer modules that are displayed together). That is, the worklist interface may be configured to basically include a part showing a worklist in the form of a table and screen regions corresponding to additional functions/activities, such as a report. The sizes, number and display formats of the screen regions corresponding to additional functions/activities may be optimized by taking into account the display environment.

The user-specified worklist interface is implemented in the form of a plurality of templates based on the role, as illustrated in FIGS. 3A through 3F. The user-specified worklist interface may be selected by taking into account at least one of the display environment, the user's personal preference, and the characteristics of the medical image to be displayed (a modality, the type of lesion, the type of organ to be displayed, etc.). Furthermore, weights may be allocated to respective screen regions of the user-specified worklist interface and then the sizes of the screen regions may be adjusted, if necessary.

### 5. Control for Display of Detailed Information and Medical Image on Software Viewer Modules <S505>

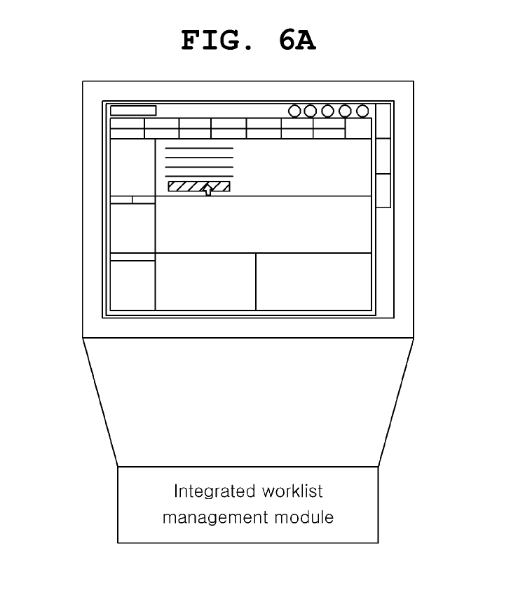

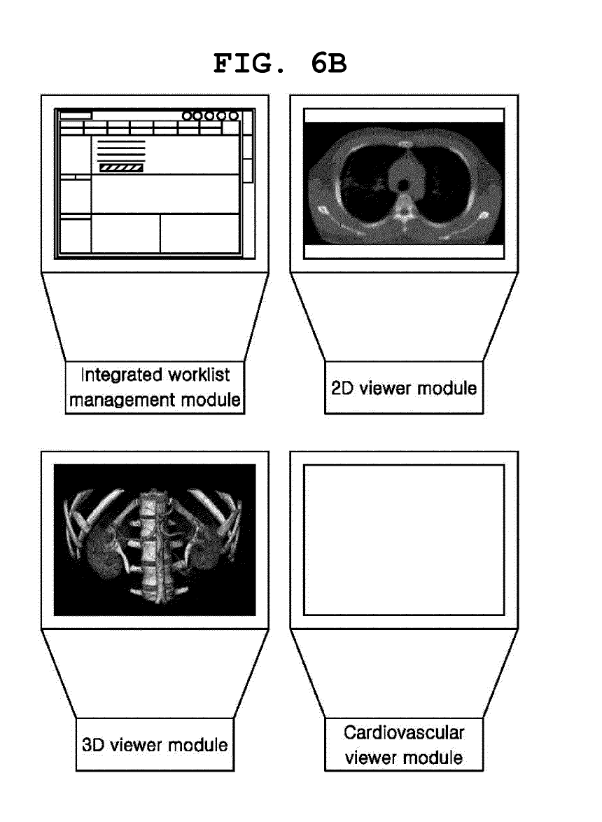

The display controller module 130 performs control so that detailed information and medical images related to a list selected from the user-specified worklist by the logged-in user via the worklist interface are displayed on the one or more software viewer modules 110. Accordingly, the user selects a list required for himself or herself from the user-specified worklist (FIG. 6A), and reads and examines a medical image or patient information provided onto the screens of the monitors 160 via the software viewer modules 110 in response to the selection (FIG. 6B), as illustrated in FIGS. 6A and 6B.

In this case, it is preferred that the software viewer modules 110 include specialized software viewer modules, such as a 2D software viewer module, a 3D software viewer module and a cardiovascular software viewer module, as in the example of FIGS. 6A and 6B, thereby being specialized for corresponding processes and then providing medical information. The reason for this is that to accurately determine the disease of a patient, only the provision of an imaged region in two dimensions may be sufficient or the realistically visualized provision of an image region in three dimensions may be required.

Meanwhile, at this step, the display controller module 130 controls layouts and locations on the screens of the monitors 160 on which the worklist interface and the software viewer modules 110 are displayed in accordance with the number of one or more software viewer modules 110 and a display environment (attribute information, such as the number and sizes of monitors), thereby adjusting the layout and location of the user-specified worklist that is displayed on the screens of the monitors 160, as illustrated in the example of FIGS. 3A through 3F.

Furthermore, the display controller module 130 functions to perform control so that detailed information and a medical image related to a list selected from the user-specified worklist are displayed via the one or more software viewer modules 110 in accordance with the status information (the number of software viewer modules, information about whether the number of software viewer modules is consistent with the number of monitors, and layouts and locations on the screens of the monitors on which the software viewer modules are displayed) of the one or more software viewer modules 110. The display controller module 130 determines the number of one or more software viewer modules 110 based on the role of the logged-in user. That is, since required medical images vary depending on whether a user is a radiologist or a technician, it is preferred that the display control module 130 determines specialized software viewer modules suitable for medical information and the number of software viewer modules, as illustrated in FIGS. 4A through 4D. Since an example related to this has been described in detail in the section <Description of System >, a description thereof is omitted.

### 6. Display of Detailed Information and Medical Image <S506>

The software viewer modules 110 receives control signals from the display controller module 130, and displays detailed information and medical images corresponding to a list selected by the user on the screens of the monitors 160.

As described above, a user-specified worklist corresponding to a logged-in user is provided via a worklist interface that provides functions varying depending on the role of the logged-in user, and thus a worklist including functions required for each user can be provided, thereby achieving the effect of being convenient for use.

Furthermore, the user-specified worklist management module 120 and the software viewer modules 110 are configured independently of each other, and thus medical information corresponding to a list can be provided in accordance with each of the specialized software viewer modules 110 when a user selects the list from a user-specified worklist, thereby achieving the effect of being convenient for use and the effect of rapidly making an update with the information of a list.

Moreover, the display controller module 130 performs control so that the detailed information and one or more medical images of a list selected from a user-specified worklist are displayed via one or more software viewer modules 110 in accordance with the status information of the software viewer modules 110, that is, by taking into account the role of a user, the status information of the software viewer modules 110 and a display environment, thereby achieving the effect of providing medical information using an optimum UI that is most convenient for the use of the user.

### 7. Update with Changed List Information <S507>

In the present invention, it is preferred that when the information of the list selected from the user-specified worklist changes, the user-specified worklist management module 120 make an update with the changed information of the list and transfer it to the one or more software viewer modules 110, thereby minimizing errors.

The method of providing a medical image according to an example of the present invention may be implemented in the form of program instructions that can be executed by a variety of computer means, and may be stored in a computer-readable storage medium. The computer-readable storage medium may include program instructions, a data file, and a data structure solely or in combination. The program instructions that are stored in the medium may be designed and constructed particularly for the present invention, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory. Examples of the program instructions include not only machine language code that is constructed by a compiler but also high-level language code that can be executed by a computer using an interpreter or the like. The above-described hardware components may be configured to act as one or more software modules that perform the operation of the present invention, and vice versa.

The above description is merely an illustration of the technical spirit of the present invention, and those having ordinary knowledge in the technical field to which the present invention pertains can make modifications and variations within the range that does not depart from the essential characteristics of the present invention. Accordingly, the disclosed embodiments of the present invention are not intended to limit the technical spirit of the present invention but to illustrate the technical spirit of the present invention, and the scope of the technical spirit of the present invention is not limited to these embodiments. The range of protection of the present invention should be interpreted based on the following claims, and all technical spirit within the range equivalent to the claims should be construed as falling within the range of the rights of the present invention.

What is claimed is:

1. A computing system comprising a processor, for providing medical images, the processor is configured to:
display medical images via one or more software viewer modules on one or more displaying monitors;
provide a user-specified worklist corresponding to a logged-in user via a worklist interface on one of the one or more displaying monitors by a software user-specified worklist management module, wherein the worklist interface provides functions varying depending on a role of the logged-in user; and
control the one or more displaying monitors to display detailed information and medical images related to a list selected from the user-specified worklist via the one or more software viewer modules based on first status information of the one or more software viewer modules by a software display controller module.

2. The system of claim 1, wherein the processor is configured to:
manage the worklist corresponding to the medical images displayed on all of the one or more software viewer modules by solely the software user-specified worklist management module.

3. The system of claim 1, wherein the software user-specified worklist management module runs as a process independent of the one or more software viewer modules.

4. The system of claim 1, wherein the processor is further configured to:
determine layouts and locations of the one or more software viewer modules and the worklist interface on the one or more displaying monitors based on a number of one or more software viewer modules and second status information of the one or more displaying monitors by the software display controller module.

5. The system of claim 1, wherein the software user-specified worklist management module, when information of the list selected from the user-specified worklist changes, makes an update with the changed information of the list and then transfers the update to the one or more software viewer modules.

6. The system of claim 1, wherein the processor is further configured to:
determine a number of the one or more software viewer modules based on the role of the logged-in user.

7. The system of claim 1, wherein the role of the logged-in user corresponds to at least one of a radiologist, a clinician, a transcriber and a technician.

8. The system of claim 1, wherein the processor is further configured to:
extract the role of the logged-in user using information about the logged-in user by a login management module; and
transfer information about the role of the logged-in user to the software display controller module and the software user-specified worklist management module by the login management module.

9. A method of providing a medical image, comprising:
reading, by a processor within a computer system, a user-specified worklist corresponding to a logged-in user;
providing, by the processor within the computer system, the user-specified worklist via a worklist interface that provides functions varying depending on a role of the logged-in user; and
control, by the processor within the computer system, one or more displaying monitors to display detailed information and medical images related to a list selected from the user-specified worklist via the worklist interface by the logged-in user via one or more software viewer modules.

10. The method of claim 9, wherein the controlling comprises:
determining, by the processor within the computer system, layouts and locations of the worklist interface and the one or more software viewer modules on the one or more displaying monitors based on a number of the one or more software viewer modules and status information of the one or more displaying monitors.

11. The method of claim 9, further comprising:
updating, by the processor within the computer system, when information of the list selected from the user-specified worklist changes, with the changed information of the list and then transferring the updated information to the one or more software viewer modules.

12. The method of claim 9, wherein the controlling comprises:
determining, by the processor within the computer system, a number of the one or more software viewer modules based on the role of the logged-in user.

13. A non-transitory computer-readable medium containing program instructions executed by a processor installed in a computing system providing a medical image, wherein the program instructions comprising:
program instructions that read a user-specified worklist corresponding to a logged-in user;
program instructions that provide the user-specified worklist via a worklist interface that provides functions varying depending on a role of the logged-in user; and
program instructions that control one or more monitors to display detailed information and medical images related to a list selected from the user-specified worklist via the worklist interface by the logged-in user via one or more software viewer modules.
